(19) United States
(12) Patent Application Publication
(10) Pub. No.: US 2017/0242898 A1
(43) Pub. Date: Aug. 24, 2017

(54) PROFILES IN SUGGEST

(71) Applicant: GOOGLE INC., (US)

(72) Inventors: Sara Su, San Jose, CA (US); Bryan C. Horling, Sunnyvale, CA (US); Okan Kolak, Sunnyvale, CA (US); Koji Ashida, Mountain View, CA (US); Abigail Jones, Menlo Park, CA (US)

(73) Assignee: GOOGLE INC., MOUNTAIN VIEW, CA (US)

(21) Appl. No.: 13/728,377

(22) Filed: Dec. 27, 2012

Related U.S. Application Data
(60) Provisional application No. 61/584,790, filed on Jan. 9, 2012.

(51) Int. Cl. G06F 17/30

(52) U.S. Cl. CPC G06F 17/30554

(57) ABSTRACT

Methods, systems, and apparatus, including computer programs encoded on a computer storage medium, for receiving a search query, where the search query comprises one or more terms including an individual identifier; identifying one or more entities associated with the individual identifier; providing the one or more entities as query suggestions; receiving a selection of an entity; obtaining search results for the selected entity, where the search results are obtained using clustered resources corresponding to the selected entity; and providing the obtained search results, where the search results are presented in a social profile page corresponding to the selected entity.

### CROSS REFERENCE TO RELATED APPLICATIONS

This application is a non-provisional of and claims priority to U.S. Provisional Patent Application No. 61/584,790, filed on Jan. 9, 2012, the entire contents of which are hereby incorporated by reference.

### BACKGROUND

This specification relates to people search results.

Internet search engines aim to identify resources (e.g., web pages, images, text documents, multimedia context) that are relevant to a user's needs and to present information about the resources in a manner that is most useful to the user. Internet search engines return search results in response to a user submitted query. For example, a user query can seek resources associated with a particular individual by including a name in a query.

### SUMMARY

In general, one aspect of the subject matter described in this specification can be embodied in methods that include the actions of receiving a search query, where the search query includes one or more terms including an individual identifier; identifying one or more entities associated with the individual identifier; providing the one or more entities as query suggestions; receiving a selection of an entity; obtaining search results for the selected entity, where the search results are obtained using clustered resources corresponding to the selected entity; and providing the obtained search results, where the search results are presented in a social profile page corresponding to the selected entity.

In general, one aspect of the subject matter described in this specification can be embodied on a computer storage medium encoded with instructions that when executed by one or more computers cause the one or more computers to perform operations of receiving a search query, where the search query comprises one or more terms including an individual identifier; identifying one or more entities associated with the individual identifier; providing the one or more entities as query suggestions; receiving a selection of an entity; obtaining search results for the selected entity, where the search results are obtained using clustered resources corresponding to the selected entity; and providing the obtained search results, where the search results are presented in a social profile page corresponding to the selected entity.

In general, one aspect of the subject matter described in this specification can be embodied on a system including: one or more computers and one or more storage devices storing instructions that are operable, when executed by the one or more computers, to cause the one or more computers to perform operations of: receiving a search query, where the search query comprises one or more terms including an individual identifier; identifying one or more entities associated with the individual identifier; providing the one or more entities as query suggestions; receiving a selection of an entity; obtaining search results for the selected entity, where the search results are obtained using clustered resources corresponding to the selected entity; and providing the obtained search results, where the search results are presented in a social profile page corresponding to the selected entity.

These and other embodiments can optionally include one or more of the following features. The method further includes refining the search results using the one or more terms in the search query. The one or more terms include an occupation identifier. The one or more terms include an organization identifier. The method further includes receiving a second search query, where the second search query includes one or more second terms; refining the identified search results using the one or more second terms; and presenting the refined search results, where the search results are presented in a social profile page corresponding to the selected entity.

Obtaining search results for the selected entity, where the search results are obtained using clustered resources corresponding to the selected entity includes identifying one or more social profiles associated with the individual identifier. Social profiles are identified based in part on a geographic location of a user. Social profiles are identified based in part on a history of search queries received for a user. Social profiles are identified based in part on inclusion in a social circle associated with a user. Presenting the identified search results includes presenting one or more mechanisms for contacting the selected entity. Presenting the obtained search results comprises providing a mechanism for requesting that the selected entity join a social group associated with a user. Receiving a search query includes receiving at least a portion of the search query.

In general, one aspect of the subject matter described in this specification can be embodied in methods that include the actions of receiving a search query, where the search query comprises one or more terms including an individual identifier; identifying an entity associated with the individual identifier; obtaining search results for the identified entity, where the search results are obtained using clustered resources corresponding to the identified entity; and providing the obtained search results, where the search results are presented in a social profile page corresponding to the identified entity.

In general, one aspect of the subject matter described in this specification can be embodied on a computer storage medium encoded with instructions that when executed by one or more computers cause the one or more computers to perform operations of: receiving a search query, where the search query comprises one or more terms including an individual identifier; identifying an entity associated with the individual identifier; obtaining search results for the identified entity, where the search results are obtained using clustered resources corresponding to the identified entity; and providing the obtained search results, where the search results are presented in a social profile page corresponding to the identified entity.

In general, one aspect of the subject matter described in this specification can be embodied on a system including: one or more computers and one or more storage devices storing instructions that are operable, when executed by the one or more computers, to cause the one or more computers to perform operations of: receiving a search query, where the search query comprises one or more terms including an individual identifier; identifying an entity associated with the individual identifier; obtaining search results for the identified entity, where the search results are obtained using clustered resources corresponding to the identified entity; and providing the obtained search results, where the search results are presented in a social profile page corresponding to the identified entity.

These and other embodiments can optionally include one or more of the following features. The entity is identified based in part on a geographical location of a user submitting the search query. The entity is identified based in part on a history of search queries submitted by a user submitting the search query. The entity is identified based in part on inclusion in a social circle associated with a user submitting the search query.

Particular embodiments of the subject matter described in this specification can be implemented so as to realize one or more of the following advantages. Search results corresponding to particular individuals can be obtained and provided for presentation. User interface elements present results to help the user recognize a “correct” individual (e.g., when multiple individuals share a name), for example, using photos, metadata, and relevant results identified for particular individuals. Additionally, users can identify individuals associated with non-name queries, for example, occupation, organization, events, or location. Users can retrieve comprehensive search results for a particular individual. The retrieved results can include publicly available search results and content that the particular individual has chosen to share with the users through, for example, a social profile page. A user can obtain search results for a particular individual based on a determined affinity between the user and the particular individual and based on a determined popularity of the particular individual.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example search system.

FIG. 2 is a flow diagram of an example process for obtaining entity-specific search results.

FIG. 3 is an example search result page for presenting search results.

FIG. 4 is an example search result page for presenting entity-specific search results for an individual.

FIG. 5 is an example search result page for presenting entity-specific search results for an individual.

Like reference numbers and designations in the various drawings indicate like elements.

### DETAILED DESCRIPTION

Users can search for individuals by submitting a search query to a search system, where the search query includes a feature. The feature can be the name of an individual, a description of an occupation, the name of an organization, or some other description associated with an individual (e.g., “president of the united states”). Particular entities can be suggested in response to a feature submitted with a search query. The suggested entities can include information (e.g., an individual's name, occupation, affiliated organization, and geographic location), where the information is obtained from a corresponding cluster of resources. The entities suggested can vary depending on different factors (e.g., the user submitting the search query, a geographic location of the user submitting the search query, or a social affinity between the user submitting the query and an individual associated with an entity). Users can select a suggested entity to obtain resources from a cluster of resources that corresponds to the selected entity.

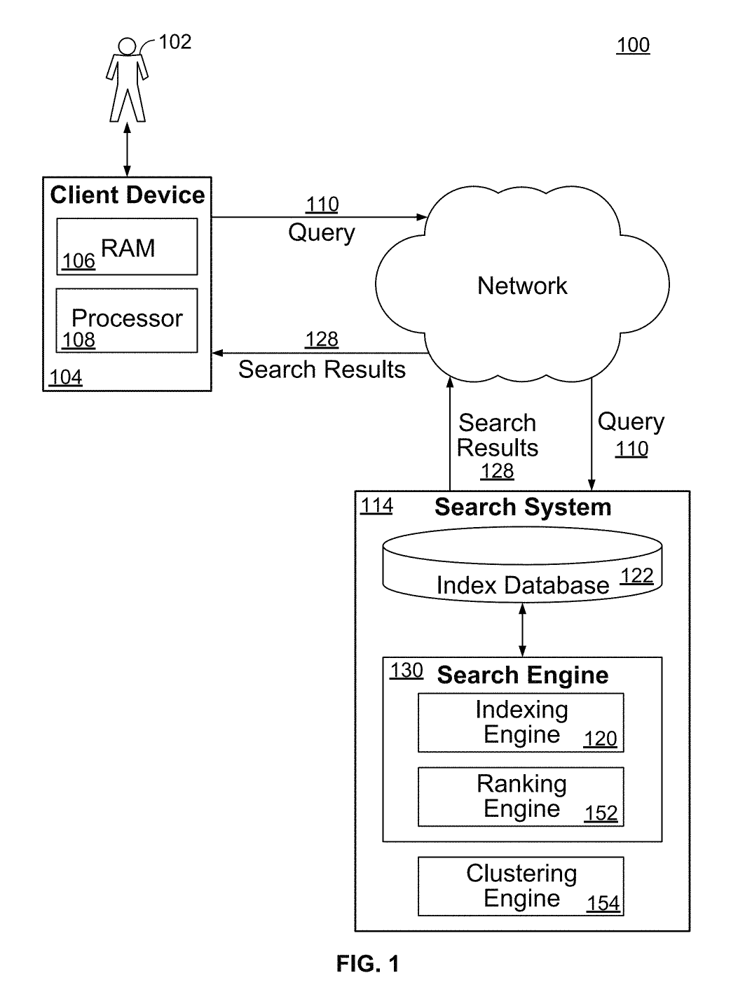

FIG. 1 shows an example system 100. The system 100 provides search results relevant to submitted queries as can be implemented in an internet, an intranet, or another client and server environment. The system 100 is an example of an information retrieval system in which the systems, components, and techniques described below can be implemented.

A user 102 can interact with a search system 114 through a client device 104. For example, the client 104 can be a computer coupled to the search system 114 through a local area network (LAN) or wide area network (WAN), e.g., the Internet. In some implementations, the search system 114 and the client device 104 can be one machine. For example, a user can install a desktop search application on the client device 104. The client device 104 will generally include a random access memory (RAM) 106 and a processor 108.

A user 102 can submit a query 110 to a search engine 130 within a search system 114. When the user 102 submits a query 110, the query 110 is transmitted through a network to the search system 114. The search system 114 can be implemented as, for example, computer programs running on one or more computers in one or more locations that are coupled to each other through a network. The search system 114 includes an index database 122 and a search engine 130. The search system 114 responds to the query 110 by generating search results 128, which are transmitted through the network to the client device 104 in a form that can be presented to the user 102 (e.g., as a search results web page to be displayed in a web browser running on the client device 104).

When the query 110 is received by the search engine 130, the search engine 130 identifies resources that match, or are responsive to, the query 110. The search engine 130 will generally include an indexing engine 120 that indexes resources (e.g., web pages, images, or news articles on the Internet) found in a corpus (e.g., a collection or repository of content), an index database 122 that stores the index information, and a ranking engine 152 (or other software) to rank the resources that match the query 110. The indexing and ranking of the resources can be performed using conventional techniques. The search system also includes a clustering engine 154 to cluster resources responsive to features (e.g., individuals, occupation, or organization). Cluster features can be included in the index database 122 or in a separate index, not shown. Alternatively, cluster features can be identified at runtime. The search engine 130 can transmit the search results 128 through the network to the client device 104 for presentation to the user 102.

In some implementations, a query is received prior to submission to the search engine 130. For example, a query can be received as it is being entered by the user 102 and before the search is executed (e.g., by selecting a “search” button). One or more suggested queries can be provided to the user 102. The suggested queries can include suggestions of particular entities.

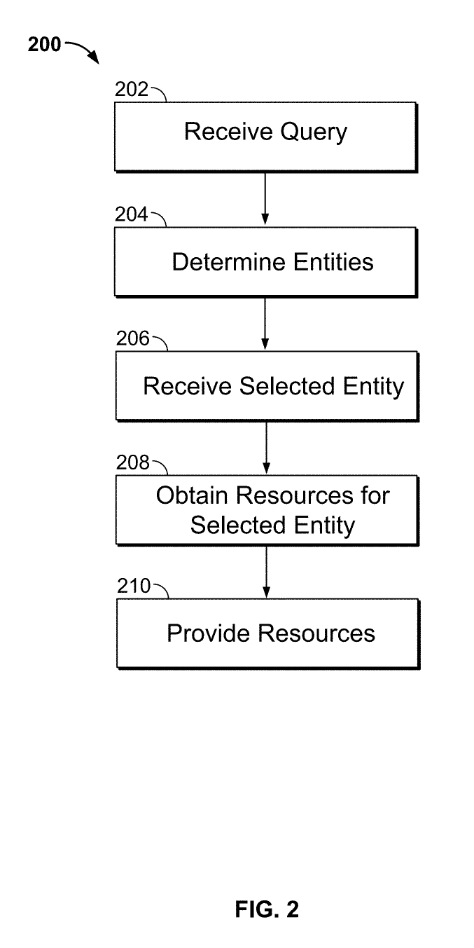

FIG. 2 is a flow diagram of an example process 200 for obtaining entity-specific search results. For convenience, the process 200 will be described with respect to a system including one or more computing devices that performs the process 200.

The system receives a search query (202). Search queries can be received from a client device communicating over a network, where the client device interacts with the system using an interface, such as a network interface. The search query can include one or more terms received from a user. For example, the search query can be “Eiffel.” In some implementations, a user enters a search query including one or more terms, where the terms include a feature. The feature can be a name for an individual and can be a full or partial name (e.g., “John,” “Doe,” “John D.,” or “Doe, J.”). In some implementations, the feature is a description of an occupation (e.g., “software engineer”), where the occupation can be used to identify one or more individuals. In some other implementations, the feature is the name of an organization (e.g., “sharks football team”), where the name of the organization can be used to identify one or more individuals. In yet some other implementations, the feature is a description associated with an individual (e.g., “president of the united states”), where the description can be used to identify one or more individuals. In some alternative implementations, the feature is a combination of one or more features (e.g., “john doe software engineer,” “john doe example corporation,” “john doe san francisco,” or “john doe the oldest man in the world”), where the feature can be used to identify one or more individuals.

During entry of the search query to the system, suggestions can be provided to the user, e.g., in a drop-down menu so that the user can select from different options. The suggestions can be suggested queries including the same or additional autocompleted query terms. In some implementations, the suggestions are based on other users' search activities. The searches can be algorithmically determined based on a number of objective factors (e.g., popularity of search terms) without human intervention. For example, the user can enter “eiffel,” and the system can suggest “Eiffel Tower,” “Eiffel Tower at night,” Eiffel Tower Paris,” and/or “Eiffel Tower pictures.” The system can provide suggestions based on a word-completion algorithm. Alternatively, the system can provide suggestions based on historical data from prior search terms.

In some implementations, the system provides suggestions for one or more entities that correspond to terms received from the user, as discussed in more detail below. For example, the user input of “John Smi” can result in a suggested query of “John Smith”. Alternatively, a user input of “John Smith” can result in a suggested query of “John Smith—Software Engineer—Mountain View, CA,” as described in greater detail below.

In some implementations, instant search results are provided based in part upon entry of one or more characters in the search query. For example, the user can enter a search query for “ei,” and search results provided can include search results with phrases “Eiffel Tower,” “Eileen Band,” and “Einstein,” each matching the search term “ei.” The user can continue with the search by inputting more characters and the search results can be updated instantly based on the entered characters. In some implementations, the search results are instantly updated based in part on the user hovering over one of the suggestions provided in the drop-down menu.

The system evaluates resources corresponding to a feature that was included in the search query to identify an entity, where the entity represents a specific instance of that feature (204). The identified entity can be the name of an individual (e.g., a “John Doe” entity), a description of an occupation (e.g., a “Software Engineer” entity), the name of an organization (e.g., an “Example Corporation” entity), or some other description associated with an individual (e.g., a “President of the United States” entity).

In some implementations, the entity is identified using resources linked with individuals, such as social profiles. A user's social profile can include a set of identified contacts, a set of links to external resources (e.g., web pages), and subscriptions to content of the system (e.g., a system that provides various content and applications including e-mail, chat, video, photo albums, or blogs). Each of these groups can be connected to other users or resources at another degree of separation from the user. For example, contacts of the user can each have their own social profile that includes links to resources and contacts. The connections to a user within a specified number of degrees of separation can be considered the social circle of the user. Users (e.g., contacts of a user) can view and interact with each other's social profiles. In such implementations, entities are identified using social profiles corresponding to a feature that was included in the search query. For example, an entity can be identified for an individual named “John Doe” if the search query included the feature “john doe,” and if a social profile for that individual is available. Additionally, features can be algorithmically determined based on a number of objective factors (e.g., popularity of search terms) without human intervention. For example, an entity can be identified for an individual named “John Doe” if the search query included the feature “john”.

In some implementations, an entity is identified based on the number of social circles in which a particular social profile has been added. For example, an entity can be set to correspond to a first “John Doe” if the number of individuals that have added the first “John Doe” to their social circle exceeds the number of individuals that have added a second “John Doe.” In some other implementations, entity identification is based on the identity of the user submitting the search query. For example, the system can determine the identity of a user submitting the search query if the user has been authenticated (e.g., by signing into an account; Internet protocol address; or by using information stored on the user's system, e.g., cookies).

In some implementations, the entity is identified based on a social affinity score between the user submitting the search query and one or more individuals. For example, social profiles corresponding to individuals named “John Doe” can include profiles for a first, second, and third “John Doe.” Upon receiving a search query for “John Doe,” the system can evaluate a social affinity score for each social profile. The social affinity score can represent a level of interaction between the user submitting the search query and each social profile (e.g., the number of times the user has viewed a social profile, the level of communication between the user and an individual's social profile, whether an individual is in the user's social circle).

For example, if the user submitting the search query is determined to interact more frequently with the social profile for the third “John Doe,” then the “John Doe” entity can be set to correspond to the social profile for the third “John Doe.” In other words, the social affinity score can be used to allow the user to find a particular individual (e.g., someone the user personally knows) amongst other individuals that share the same name. In this example, a cluster of resources corresponding to the “John Doe” entity (i.e., resources responsive to the third “John Doe”) can be searched to obtain responsive search results.

An entity can also be identified using resources (e.g., documents, web pages, and images) in a cluster of resources for a feature. In some implementations, an entity is identified based on a count of a number of resources that are responsive to a specific instance of a feature. For example, if resources responsive to individuals named “Jane Doe” include references to a first, second, and third “Jane Doe,” and the number of resources responsive to the second “Jane Doe” exceed the number of resources for the first or third “Jane Doe,” then a “Jane Doe” entity can be set to correspond to the second “Jane Doe.” In this example, a cluster of resources corresponding to the “Jane Doe” entity (i.e., resources determined to be responsive to the second “Jane Doe”) can be searched to obtain responsive search results.

In some other implementations, an entity is identified using the popularity of resources (e.g., documents, web pages, and images) in a cluster of resources for a feature. For example, if resources responsive to individuals named “Jane Doe” include references to a first, second, and third “Jane Doe,” and the resources responsive to the first “Jane Doe” are determined to be more popular (e.g., a higher search engine ranking) than the second or third “Jane Doe,” then a “Jane Doe” entity can be set to correspond to the first “Jane Doe.” In this example, a cluster of resources corresponding to the “Jane Doe” entity (i.e., resources responsive to the first “Jane Doe”) can be searched to obtain responsive search results.

In some other implementations, an entity is identified using information from a user's browsing history. For example, if a user submitting a search query previously searched for a particular individual, then an entity can be set to correspond to that particular individual, where a search using that entity can obtain search results responsive to the particular individual.

In yet some other implementations, an entity is identified using a geographic location associated with the user submitting a search query. For example, resources responsive to individuals named “John Doe” may contain references to a first “John Doe,” who is located in San Francisco and a second “John Doe,” who is located in Los Angeles. An entity can be set to correspond to the first “John Doe” in a case where the geographic location for a user submitting a search query is determined to be San Francisco. Similarly, an entity can be set to correspond to the second “John Doe” in a case where the geographic location for a user submitting a search query is determined to be Los Angeles.

Entities can also be associated with features that reference an occupation, an organization, or a description for an individual. In some implementations, an occupation entity is identified using resources associated with individuals that list an occupation for that individual. For example, a social profile for an individual named “John Doe” that lists “Software Engineer” as an occupation can be used to identify a “Software Engineer” entity. In some implementations, the occupation entity can be used to search a cluster of resources to identify one or more individuals of that occupation.

For example, a “Software Engineer” entity can be used to search a related cluster of resources (e.g., web pages of software engineers, documents written by software engineers, web pages for software companies) to identify one or more individuals who are software engineers. Specific individuals within this cluster of resources can be identified using one or more of the described techniques (e.g., based on the number of social circles in which a particular social profile has been added, a social affinity score between the user submitting the search query and one or more individuals, the number of resources determined to be responsive for an individual, the popularity of resources for an individual, the browsing history of a user submitting a search query, and the geographic location of a user submitting a search query). In some implementations, the search query includes features that reference an individual and an occupation, where an entity is set to correspond to the individual that practices the referenced occupation.

In some other implementations, an organization entity is identified using resources associated with individuals that list an organization with which that individual is associated. For example, a social profile for an individual named “John Doe” that lists “Example Corporation” as an organization can be used to identify an “Example Corporation” entity. In some implementations, the organization entity can be used to search a cluster of resources to identify one or more individuals associated with that organization. In some implementations, the search query includes features that reference an individual and an organization, where an entity is set to correspond to the individual that is affiliated with the referenced organization.

In some other implementations, an Internet protocol address, or a domain name system address, associated with a user submitting a search query is used to identify an entity. For example, assuming an “example.com” domain name system address corresponds to an organization named “Example Corporation,” if a user submits a search query that originates from an “example.com” domain name system address, then an entity can be set to correspond to the “Example Corporation” organization. In particular, the user's search query can be filtered to obtain resources that are associated with the “Example Corporation” entity.

Additionally, if a user submits a search query for individuals named “Jane Doe” then an entity can be set to correspond to “Example Corporation,” where search for individuals named “Jane Doe” can be filtered to one or more individuals named “Jane Doe” that are associated with “Example Corporation.” In such implementations, the search results can be refined further using one or more techniques described above to identify a particular “Jane Doe” (e.g., based on the number of social circles in which a particular social profile has been added, a social affinity score between the user submitting the search query and one or more individuals, the number of resources determined to be responsive for an individual, the popularity of resources for an individual, the browsing history of a user submitting a search query, and the geographic location of a user submitting a search query).

The system provides one or more entities for selection (204). A user entering a search query can be presented one or more autocomplete suggestions (e.g., in a drop-down menu), where the user can submit a search query upon selection of one of the suggestions. In some implementations, the identified entity is presented as a suggestion in a list of suggestions. For example, in response to a user entering a search query for “john doe,” the system can present suggestions “john doe,” “john doe lyrics,” “john doe tv show,” and a “John Doe” entity. In some implementations, the presented “John Doe” entity can include a visual identifier associated with the entity and corresponding information (e.g., occupation and affiliated organization).

The system receives a selection of an entity (206). The user can select a presented entity, where selection of that entity triggers a search within a cluster of resources that corresponds to the entity. In some implementations, a selected entity is refined by adding one or more terms to the search query. For example, a “Jane Doe” entity can be refined by the user by adding one or more terms (“software engineer”) in a search query box, where the additional terms can be used to refine resources that were obtained as being responsive to the “Jane Doe” entity. In this example, resources that were obtained as being responsive to the “Jane Doe” entity can be filtered to obtain resources related to the additional terms “software engineer.”

The system obtains resources responsive to the selected entity (208). In some implementations, the system obtains resources (e.g., documents, web pages, images) from a cluster of resources, where the resources are responsive to the selected entity. For example, if resources responsive to individuals named “Jane Doe” include references to a first, second, and third “Jane Doe” and the selected entity corresponds to the third “Jane Doe,” then the system obtains resources responsive to the third “Jane Doe.”

Each entity can be linked to a particular cluster of resources (e.g., documents, web pages, and images) that correspond to that entity. In some implementations, the cluster of resources can include metadata (e.g., pictures, keywords, or other personally relevant information) determined to be responsive to the identified entity. A cluster of resources can be created in an offline process or at runtime by a clustering engine (e.g., clustering engine 154 of FIG. 1). The clustering engine can create a cluster of resources for a particular entity by identifying resources that are associated with the particular entity. Resources can be identified, for example, by searching an index of resources and the identified resources can be associated with particular entities based on the particular entities occurring in the resource content or metadata associated with those particular entities.

The system provides the obtained resources to the user (210). For example, a search results page can be provided for presentation (e.g., by a client browser) that includes resources that were obtained from a cluster of resources for a selected entity. The obtained resources can include results associated with images, web pages, audio, video resources, social content (e.g., social profile posts authored by the entity), or authored content (e.g., articles authored by the entity). The obtained resources can be provided in a ranked order as determined using one or more ranking criteria (e.g., popularity). In some implementations, the ranked order is based in part on a ranking of resources within a cluster of resources for a selected entity, where the ranking is performed using search engine ranking criteria. In some other implementations, resources are obtained based in part on ranking and category (e.g., web pages, documents, or images), where the resources are obtained in a ranked order within a specified category. For example, the obtained resources can include the top five web pages and the top five images corresponding to the selected entity.

In some implementations, the obtained resources for the selected entity are provided in a manner that facilitates user recognition of the selected entity and resources corresponding to the selected entity. For example, the presentation of obtained resources can include a variety of information for the selected entity (e.g., the name of an individual, occupation, employer, geographic location, organization, images related to the individual, links to resources within a related cluster of resources, social connections to other people, metadata, or other summaries as derived from the underlying cluster of resources. The metadata can include, for example, keywords or other relevant, distinguishing textual features.

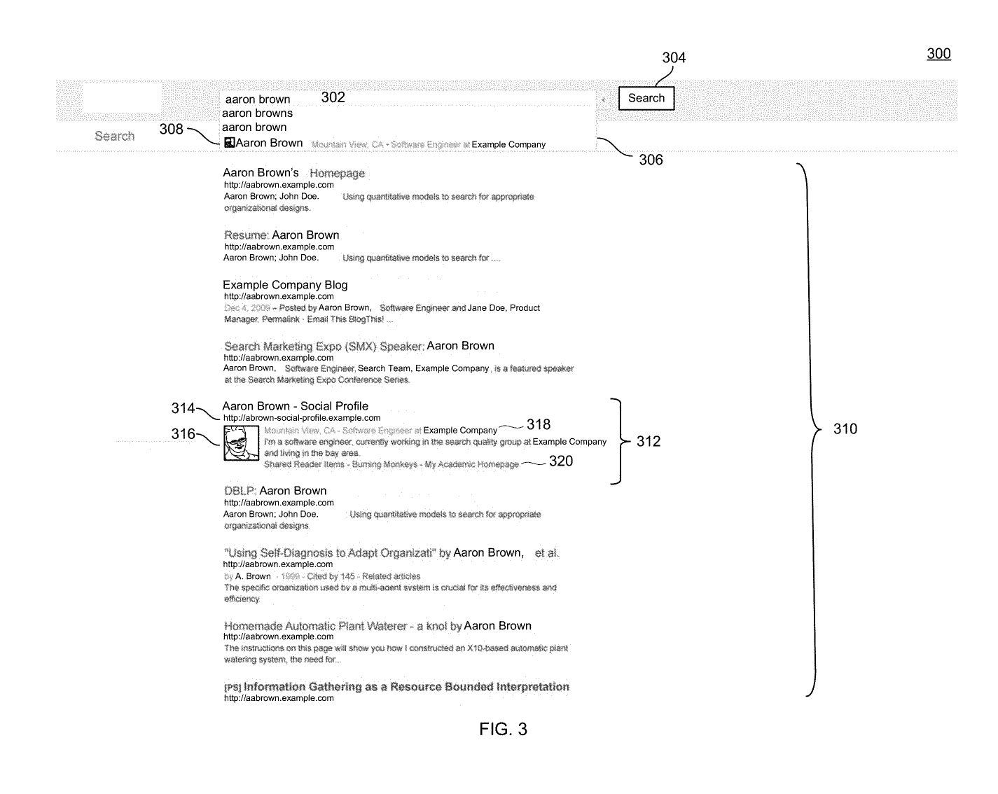

FIG. 3 is an example search result page 300 for presenting search results. The search results page 300 can include a search box 302 with a search button 304. In FIG. 3, the search query in the search box 302 is populated with the terms “aaron brown.” A drop-down menu 306 displaying other suggested queries related to the terms “aaron brown” are shown below the search box 302. In particular, an entity 308 corresponding to a particular individual named “Aaron Brown” is also presented as a suggestion. The suggested entity 308 is shown with an icon associated with the entity and a description for the entity, where the description identifies the name of the particular individual associated with the entity (“Aaron Brown”), the individual's geographic location (“Mountain View, CA”), the individual's occupation (“Software Engineer”), and the individual's organization (“Example Corporation”).

In some implementations, two or more entities can be presented as suggestions, where each entity corresponds to a particular instance of a feature (e.g., individual, occupation, or organization). For example, the drop-down menu 306 can present an additional entity for a second individual also named “Aaron Brown,” where the second “Aaron Brown” can have a different geographic location (e.g., “San Diego, CA”), a different occupation (e.g., “Project Manager”), or a different organization (e.g., “Example Inc.”).

Instant search results 310 responsive to the terms “aaron brown” are presented. The instant search results 310 are provided based on entry of the terms “aaron brown,” and include search results responsive to one or more individuals named “Aaron Brown.” The user can continue with the search by inputting more characters and the search results can be updated instantly based on the entered characters. In some implementations, the search results are instantly updated based in part on the user hovering over one of the suggestions 306 provided in the drop-down menu. For example, the user can select the “Aaron Brown” entity 308 from the drop-down menu and, in response, the search results can be instantly updated to display search results responsive to the entity 308.

A social profile 312 corresponding to the suggested “Aaron Brown” entity 308 is also presented. A social profile can be a profile created by an individual or an organization that includes information and links to resources and contacts. In FIG. 3, the social profile 312 is a profile corresponding to an individual named “Aaron Brown.” The social profile 312 includes a website address 314 for accessing the social profile, a visual indicator 316, and corresponding geographic location, occupation, and organization 318 for “Aaron Brown.” The social profile 312 also includes additional links 320 (e.g., shared posts or personal websites). In some implementations, the search results 310 are ranked based in part on search engine ranking criteria. In some other implementations, the search results 310 are ranked based in part on a social connection to the user submitting the search query, where search results for individuals having a social connection to the user submitting the search query are positioned higher than search results for other individuals.

Similarly, other factors can be used to rank search results 310 (e.g., based on the number of social circles in which a particular social profile has been added, a social affinity score between the user submitting the search query and an individual, the number of resources determined to be responsive for an individual, the popularity of resources for an individual, the browsing history of a user submitting a search query, and the geographic location of a user submitting a search query).

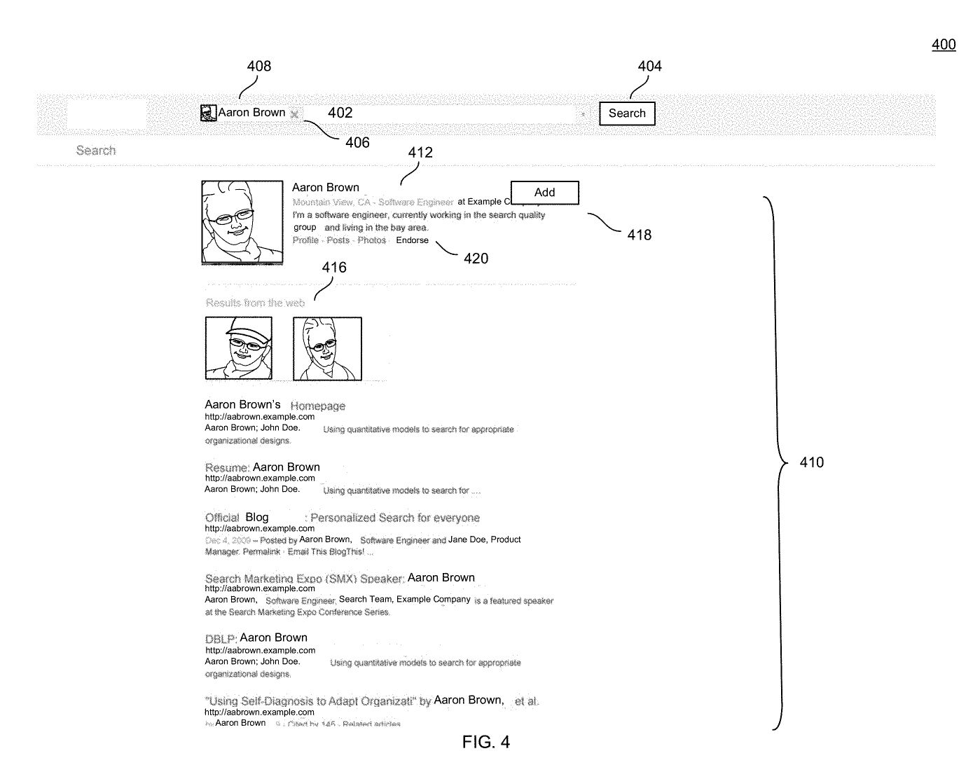

FIG. 4 is an example search result page 400 for presenting entity-specific search results for an individual. The search results page 400 can include a search box 402 with a search button 404. In FIG. 4, the search query in the search box 402 is populated with an entity 408 corresponding to a particular individual named “Aaron Brown.” A user can select the search button 404 to search a cluster of resources using the “Aaron Brown” entity 408 to obtain resources (e.g., documents, web pages, images) responsive to the entity 408, where the obtained resources correspond to the particular individual named “Aaron Brown.” In some implementations, resources responsive to the entity 408 are displayed upon entering the entity 408 into the search box 402, such that selection of the search button 404 is not needed. The entity 408 is shown with an icon associated with the entity and with a cancellation option 406 (shown as an “X”). A user can select the cancellation option to remove the entity 408 from the search box 402. Removal of the entity 408 can cancel the entity-based search.

Search results 410 and a social profile 412 responsive to the entity 408 corresponding to “Aaron Brown” are presented. The social profile 412 provides information for the individual associated with the “Aaron Brown” entity, including the individual's name (“Aaron Brown”), the individual's geographic location (“Mountain View, CA”), the individual's occupation (“Software Engineer”), and the individual's organization (“Example Corporation”). A description of the individual 418 is also shown, where the description can be provided by the owner of the social profile.

The search results 410 can include information (e.g., pictures, keywords, or other personally relevant information) determined to be responsive to the identified entity. In this regard, images 416 corresponding to the “Aaron Brown” entity are also presented. In some implementations, options 420 for interacting with the individual are presented. In particular, a user can select a “Profile” option to access a more detailed social profile for the individual. A “Posts” option can be selected to access posts (e.g., blog posts, social posts, articles) authored by the individual. A “Photos” option can be selected to access photographs associated with the individual. An “Endorse” option can be selected to endorse the individual, where the user's endorsements (e.g., web pages, posts, images) can be presented on the user's social profile. In some other implementations, a social post authored by the entity is presented in place of the options 420.

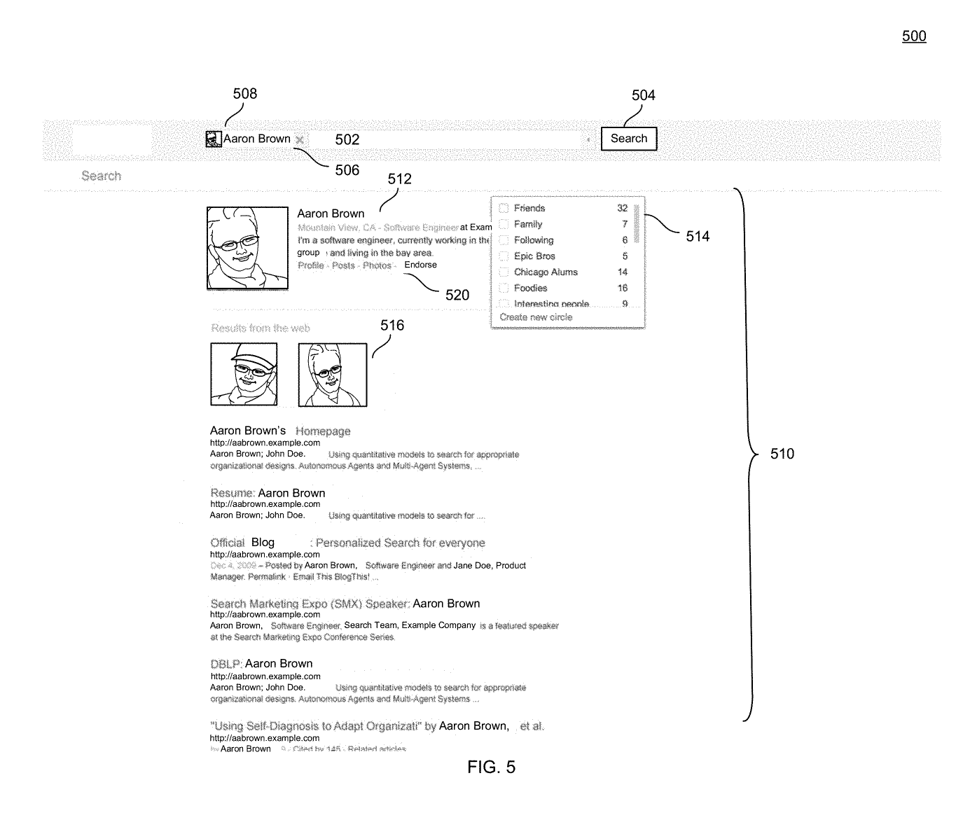

FIG. 5 is an example search result page 500 for presenting entity-specific search results for an individual. The search results page 500 can include a search box 502 with a search button 504. In FIG. 5, the search query in the search box 502 is populated with an entity 508 corresponding to a particular individual named “Aaron Brown.” The entity 508 is shown with an icon associated with the entity and with a cancellation option 506 (shown as an “X”). A user can select the cancellation option to remove the entity 508 from the search box 502, where removal of the entity can cancel the entity-based search.

Search results 510 responsive to the entity corresponding to “Aaron Brown” are presented. A social profile 512 corresponding to the “Aaron Brown” entity 508 is presented. The social profile 512 provides information for the individual associated with the “Aaron Brown” entity, including the individual's name (“Aaron Brown”), the individual's geographic location (“Mountain View, CA”), the individual's occupation (“Software Engineer”), and the individual's organization (“Example Corporation”). Image search results 516 corresponding to the “Aaron Brown” entity are presented. In some implementations, options 520 for interacting with the individual are also presented. In particular, a user can select a “Profile” option to access a more detailed social profile for the individual. A “Posts” option can be selected to access posts (e.g., blog posts, social posts, articles) authored by the individual. A “Photos” option can be selected to access photographs associated with the individual. An “Endorse” option can be selected to add the individual to a social circle. A social circles window 514 can be displayed in response to selection of the “Endorse” option. The social circles window 514 allows a user to add the social profile 512 to one of their social circles. In some other implementations, a social post authored by the entity is presented in place of the options 520.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, the method comprising:
receiving an entry of at least a portion of a search query comprising one or more terms input into a search field provided by a client device, wherein the one or more terms include an individual identifier that identifies multiple distinct individuals having a same name;
prior to execution of the search query,
using the individual identifier to identify at least two individuals having the same name, including a first individual and a second individual;
providing a plurality of suggested queries for display on the client device relative to the one or more input terms, the suggested queries including a first suggested query referring to the first individual and a second suggested query referring to the second individual, including providing the same name in both the first and the second suggested queries, and including providing further information distinguishing in the suggested queries the first individual referred to by the first suggested query from the second individual identified by the second suggested query; and
responsive to receiving from the client device a selection of the first suggested query or the second suggested query:
obtaining search results for the selected individual of the selected query, where the search results are obtained using resources associated with the selected individual; and
providing the obtained search results to the client device.

2. The method of claim 1, further comprising: refining the obtained search results using the one or more terms in the search query.

3-4. (canceled)

5. The method of claim 1, further comprising:
receiving a second search query, wherein the second search query comprises one or more second terms;
refining the obtained search results using the one or more second terms; and
providing the refined search results, wherein the search results are presented in a social profile page corresponding to the selected individual.

6. The method of claim 1, wherein using resources associated with the selected individual comprises identifying one or more social profiles associated with the individual identifier.

7. The method of claim 6, wherein the social profiles are identified based in part on a geographic location of a user submitting the search query.

8. The method of claim 6, wherein the social profiles are identified based in part on a history of search queries received for a user submitting the search query.

9. The method of claim 6, wherein the social profiles are identified based in part on being included in a social circle associated with a user submitting the search query.

10. The method of claim 1, wherein providing the further information comprises:
providing, in the first suggested query, an indication of a geographic location of the first individual; and
providing, in the second suggested query, an indication of a geographic location of the second individual.

11. The method of claim 1, wherein providing the obtained search results comprises providing a mechanism for requesting that the selected individual join a social group associated with a user.

12-16. (canceled)

17. A system comprising:
one or more computers and one or more storage devices storing instructions that are operable, when executed by the one or more computers, to cause the one or more computers to perform operations comprising:
receiving an entry of at least a portion of a search query comprising one or more terms input into a search field provided by a client device, wherein the one or more terms include an individual identifier that identifies multiple distinct individuals having a same name;
prior to execution of the search query,
using the individual identifier to identify at least two individuals having the same name, including a first individual and a second individual;
providing a plurality of suggested queries for display on the client device relative to the one or more input terms, the suggested queries including a first suggested query referring to the first individual and a second suggested query referring to the second individual, including providing the same name in both the first and the second suggested queries, and including providing further information distinguishing in the suggested queries the first individual referred to by the first suggested query from the second individual identified by the second suggested query, wherein the further information comprises (i) an indication of a geographic location of the first individual in the first suggested query, and (ii) an indication of a geographic location of the second individual in the second suggested query; and
responsive to receiving from the client device a selection of the first suggested query or the second suggested query:
obtaining search results for the selected individual of the selected query, where the search results are obtained using resources associated with the selected individual; and
providing the obtained search results to the client device.

18. The system of claim 17, further comprising: refining the obtained search results using the one or more terms in the search query.

19-20. (canceled)

21. The system of claim 17, further comprising:
receiving a second search query, wherein the second search query comprises one or more second terms;
refining the obtained search results using the one or more second terms; and
providing the refined search results, wherein the search results are presented in a social profile page corresponding to the selected individual.

22. The system of claim 17, wherein using resources associated with the selected individual comprises identifying one or more social profiles associated with the individual identifier.

23. The system of claim 22, wherein the social profiles are identified based in part on a geographic location of a user submitting the search query.

24-27. (canceled)

28. A non-transitory computer storage medium encoded with instructions that when executed by one or more computers cause the one or more computers to perform operations comprising:
receiving an entry of at least a portion of a search query comprising one or more terms input into a search field provided by a client device, wherein the one or more terms include an individual identifier that identifies multiple distinct individuals having a same name;
prior to execution of the search query,
using the individual identifier to identify at least two individuals having the same name, including a first individual and a second individual;
providing a plurality of suggested queries for display on the client device relative to the one or more input terms, the suggested queries including a first suggested query referring to the first individual and a second suggested query referring to the second individual, including providing the same name in both the first and the second suggested queries, and including providing further information distinguishing in the suggested queries the first individual referred to by the first suggested query from the second individual identified by the second suggested query; and
responsive to receiving from the client device a selection of the first suggested query or the second suggested query:
obtaining search results for the selected individual of the selected query, where the search results are obtained using resources associated with the selected individual; and
providing the obtained search results to the client device.

29. The computer storage medium of claim 28, further comprising: refining the obtained search results using the one or more terms in the search query.

30-31. (canceled)

32. The computer storage medium of claim 28, further comprising:
receiving a second search query, wherein the second search query comprises one or more second terms;
refining the obtained search results using the one or more second terms; and
providing the refined search results, wherein the search results are presented in a social profile page corresponding to the selected individual.

33. The computer storage medium of claim 28, wherein using resources associated with the selected individual comprises identifying one or more social profiles associated with the individual identifier.

34. The computer storage medium of claim 33, wherein the social profiles are identified based in part on a geographic location of a user submitting the search query.

35. The system of claim 17, wherein providing the obtained search results comprises providing one or more mechanisms for contacting the selected individual.

36. The system of claim 17, wherein providing the obtained search results comprises providing a mechanism for requesting that the selected individual join a social group associated with a user.

37. The system of claim 22, wherein the social profiles are identified based in part on a history of search queries received for a user submitting the search query.

38. The system of claim 22, wherein the social profiles are identified based in part on being included in a social circle associated with a user submitting the search query.

39. The system of claim 17, wherein the operations further comprise providing, with the first suggested query or the second suggested query, a visual indicator that distinguishes the first individual referred to by the first suggested query from the second individual identified by the second suggested query.

40. The system of claim 17, wherein the further information comprises an image of the first individual and an indication of at least a geographic location, an occupation, or an organization of the first individual.

41. The method of claim 1, further comprising providing, with the first suggested query or the second suggested query, a visual indicator that distinguishes the first individual referred to by the first suggested query from the second individual identified by the second suggested query.

42. The method of claim 1, wherein the further information comprises an image of the first individual or an image of the second individual.

43. The computer storage medium of claim 28, wherein providing the obtained search results comprises providing one or more mechanisms for contacting the selected individual.

44. The computer storage medium of claim 28, further comprising:
identifying multiple social networking profiles responsive to the query, each of the profiles corresponding to a different individual; and
determining, for each of the multiple social networking profiles, an affinity score that represents a level of interaction between a user submitting the search query and the individual corresponding to the social networking profile;
wherein providing the suggested queries or obtaining the search results is based on the affinity scores.

45. The computer storage medium of claim 33, wherein the social profiles are identified based in part on a history of search queries received for a user submitting the search query.

46. The computer storage medium of claim 33, wherein the social profiles are identified based in part on being included in a social circle associated with a user submitting the search query.

47. The computer storage medium of claim 28, wherein the operations further comprise providing, with the first suggested query or the second suggested query, a visual indicator that distinguishes the first individual referred to by the first suggested query from the second individual identified by the second suggested query.

48. The computer storage medium of claim 28, wherein the further information comprises an image of the first individual or an image of the second individual.
